(19) United States
(12) Patent Application Publication
(10) Pub. No.: US 2013/0005913 A1
(43) Pub. Date: Jan. 3, 2013

(54) METHOD FOR TREATING THE ELASTOMER SURFACE OF A DEVICE FOR DISPENSING A FLUID PRODUCT

(75) Inventors: Pascal Bruna, Sotteville Les Rouen (FR); Marie Legoguelin, Rouen (FR); Matthieu Laurent, Vaucresson (FR); Sébastien Roussel, Soisy Sur Seine (FR); Lorraine Tessier, Montrouge (FR)

(73) Assignee: VALOIS SAS, Le Neubourg (FR)

(21) Appl. No.: 13/515,646

(22) PCT Filed: Dec. 22, 2010
(86) PCT No.: PCT/FR2010/052885

§ 371 Date: Aug. 23, 2012

(30) Foreign Application Priority Data
Dec. 23, 2009 (FR) 0959502

(51) Int. Cl. C08F 279/02; B05D 1/18

(52) U.S. Cl. 525/288; 427/430.1; 427/2.1

(57) ABSTRACT

A treatment method for treating an elastomer surface of a fluid dispenser device, the method including the step of using chemical grafting to form a thin film on at least one support surface of at least one elastomer surface of the dispenser device, the thin film avoiding the elastomer surfaces sticking during the manufacturing and assembly stages.

The present invention relates to a treatment method for treating an elastomer surface for fluid dispenser devices.

Fluid dispenser devices are well known. They generally comprise: a reservoir; a dispenser member, such as a pump or a valve; and a dispenser head that is provided with a dispenser orifice. Elastomer parts, such as gaskets, present certain drawbacks, in particular during manufacturing and assembly stages. Thus, in order to avoid sticking that is likely to block a manufacturing and/or assembly line, the gaskets need to be dusted with talc, washed, and dried. Those processes complicate the manufacture and assembly of the dispenser devices concerned. Similar problems may occur with other elastomer parts, e.g. pump pistons.

An object of the present invention is to propose a treatment method for treating an elastomer surface, in particular a gasket, that avoids the above-mentioned drawbacks.

In particular, an object of the present invention is to provide a treatment method for treating an elastomer surface, which method is effective, long-lasting, non-polluting, and simple to perform.

The present invention thus provides a treatment method for treating an elastomer surface of a fluid dispenser device, said method comprising the step of using chemical grafting to form a thin film on at least one support surface of at least one elastomer surface of said dispenser device, said thin film avoiding the elastomer surfaces sticking during the manufacturing and assembly stages.

Advantageously, said thin film includes hydrophobic agents with anti-static properties.

Advantageously, said chemical grafting creates covalent bonds between the molecules of said thin film and said support surface.

In an implementation, said grafting step comprises putting the elastomer surface into contact, in non-electrochemical conditions, with a solution that includes at least one adhesive primer, said adhesive primer being a cleavable aryl salt, and at least one monomer or polymer selected from the group constituted by vinyl- or acrylic-terminated siloxanes.

The term “elastomer surface” means the surface of an elastomeric substrate, i.e. made of elastomer.

The term “elastomer” means a polymer that presents visco-elastic properties after cross-linking, and a low glass transition temperature.

In an advantageous aspect of the invention, the elastomers are vulcanized.

In an implementation, said elastomer is selected from the group of general elastomers.

The term “general elastomers” means unsaturated and apolar general-purpose elastomers having a continuous-use temperature limit that is less than 80° C.

In an implementation, the group of general elastomers comprises: natural rubber (NR); synthetic polyisoprene (IR); polybutadiene (BR); and styrene butadiene copolymer (SBR); alone or in a mixture.

In an implementation, said elastomer is selected from the group of special elastomers.

The term “special elastomers” means elastomers having a continuous-use temperature limit that is less than 150° C.

In an implementation, the group of special elastomers comprises: polyisobutylene or butyl rubber (PIB or IIR); neoprene (CR); nitrile rubber (NBR); ethylene propylene diene monomer (EPDM) or ethylene propylene monomer (EPM); styrene-butadiene-styrene (SBS); polyether block amide (PEBA); thermoplastic polyurethanes (TPU); and thermoplastics olefins (TPO); alone or in a mixture.

In an implementation, said elastomer is selected from the group of very special elastomers.

The term “very special elastomers” means elastomers that can withstand high temperature and that possess specific properties.

In an implementation, the group of very special elastomers comprises: silicone elastomers ((inorganic nature): vinyl methyl silicone (VMQ), phenyl vinyl methyl silicone (PVMQ), fluoro vinyl methyl silicone (FVMQ), and methyl silicone (MQ)); fluoroelastomers (FKM); perfluoroelastomers (FFKM); polyacrylic elastomers (ACM); acrylic ethylene (AEM); chlorosulfonated polyethylene (CSM); and epichlorohydrin elastomers (CO and ECO); alone or in a mixture.

In an implementation, said elastomers contain 10% to 95% of the specified polymers, these percentages being understood as the average quantities of polymer in an elastomer.

In an implementation, said elastomeric substrates include at least 30% of elastomers.

Advantageously, said chemical grafting is performed in an aqueous medium.

In an implementation, the cleavable aryl salt is selected from the group constituted by: aryl diazonium salts; aryl ammonium salts; aryl phosphonium salts; aryl sulfonium salts; and aryl iodonium salts.

The cleavable aryl salts are selected from compounds of general formula ArN₂⁺, X⁻ in which Ar represents the aryl group and X⁻ represents an anion. The aryl group in an organic compound is a functional group derived from an aromatic ring.

In an implementation, X⁻ anions are selected from: inorganic anions such as halides, such as I—, Cl—, and Br—; halogenoborates such as tetrafluoroborate; and organic anions such as alcoholates, carboxylates, perchlorates, and sulfonates.

In an implementation, the aryl groups Ar are selected from possibly mono- or poly-substituted aromatic or heteroaromatic groups constituted by one or more aromatic rings of 3 to 8 carbons. The heteroatoms of the heteroaromatic compounds are selected from N, O, P, and S. The substituents may contain alkyl groups and one or more heteroatoms such as N, O, F, Cl, P, Si, Br, or S.

In an implementation, the aryl groups are selected from: aryl groups substituted by attractor groups such as NO₂; COH; CN; CO₂H; amines; ketones; esters; and halogens.

In an implementation, the aryl groups are selected from the group constituted by: phenyl and nitrophenyl groups.

In an implementation, the cleavable aryl salt is selected from the group constituted by: phenyldiazonium tetrafluoroborate; 4-nitrophenyldiazonium tetrafluoroborate; 4-bromophenyldiazonium tetrafluoroborate; 4-aminophenyldiazonium chloride; 4-aminomethylphenyldiazonium chloride; 2-methyl-4-chlorophenyldiazonium chloride; 4-benzoylbenzenediazonium tetrafluoroborate; 4-cyanophenyldiazonium tetrafluoroborate; 4-carboxyphenyldiazonium tetrafluoroborate; 4-acetamidophenyldiazonium tetrafluoroborate; 4-phenylacetic acid diazonium tetrafluoroborate; 2-methyl-4-[(2-methylphenyl)diazenyl]benzenediazonium sulfate; 9,10-dioxo-9,10-dihydro-1-anthracenediazonium chloride; 4-nitronaphtalenediazonium tetrafluoroborate; and naphtalenediazonium tetrafluoroborate.

In an implementation, the cleavable aryl salt is selected from the group constituted by: 4-nitrophenyldiazonium tetrafluoroborate; 4-aminophenyldiazonium chloride; 2-methyl-4-chlorophenyldiazonium chloride; and 4-carboxyphenyldiazonium tetrafluoroborate.

In an implementation, the cleavable aryl salt concentration lies in the range 5×10⁻³ molar (M) to 10⁻¹ M.

In an implementation, the cleavable aryl salt concentration is about 5×10⁻² M.

In an implementation, the cleavable aryl salt is prepared in situ.

The term “vinyl- or acrylic-terminated siloxane” means a saturated silicon and oxygen hydride that is formed with straight or branched chains of alternating silicon and oxygen atoms and including terminating vinyl or acrylic motifs.

In an implementation, vinyl- or acrylic-terminated siloxanes are selected from the group constituted by: vinyl- or acrylic-terminated polyalkylsiloxanes such as vinyl- or acrylic-terminated polymethylsiloxane; vinyl- or acrylic-terminated polydimethylsiloxane such as polydimethylsiloxane-acrylate (PDMS-acrylate); vinyl- or acrylic-terminated polyarylsiloxanes such as vinyl- or acrylic-terminated polyphenylsiloxane such as polyvinylphenylsiloxane; and vinyl- or acrylic-terminated polyarylalkylsiloxanes such as vinyl- or acrylic-terminated polymethylphenylsiloxane.

Advantageously, said chemical-grafting step is initiated by chemically activating a diazonium salt so as to form an anchor layer for said thin film.

In an implementation, said chemical activation is initiated by the presence of a reducing agent in the solution.

In an implementation, the solution comprises a reducing agent.

The term “reducing agent” means a compound that donates electrons during a redox reaction. In an aspect of the present invention, the reducing agent presents a redox potential difference relative to the redox potential of the cleavable aryl salt, that lies in the range 0.3 volts (V) to 3 V.

In an aspect of the invention, the reducing agent is selected from the group constituted by: reducing metals that are possibly finely divided, such as iron, zinc, or nickel; a metal salt that is possibly in the form of a metallocene; and an organic reducing agent such as hypophosphorus acid, or ascorbic acid.

In an implementation, the reducing agent concentration lies in the range 0.005 M to 2 M.

In an implementation, the reducing agent concentration is about 0.6 M.

In an implementation, said thin film has a thickness that is less than 1 micrometer (μm), and that lies in the range 10 angstroms (Å) to 2000 Å, advantageously lies in the range 10 Å to 800 Å, preferably lies in the range 400 Å to 1000 Å. No conventional coating technique makes it possible to obtain chemically-grafted layers that are as thin.

Advantageously, said dispenser device comprises: a reservoir containing the fluid; a dispenser member, such as a pump or a valve, that is fastened on said reservoir; and a dispenser head that is provided with a dispenser orifice, and this is for actuating said dispenser member.

Advantageously, said elastomer surface is a neck gasket and/or a valve gasket of a dispenser member, such as a pump or a valve.

Advantageously, said fluid is a pharmaceutical for spraying in nasal or oral manner.

In an implementation, it is possible to use a method similar to the method described in document WO 2008/078052, which describes a method of preparing an organic film on the surface of a solid support under non-electrochemical conditions. Surprisingly, that type of method turns out to be suitable for forming a thin film on elastomer surfaces, in particular gaskets of fluid dispenser devices. Such an application of that grafting method has not previously been envisaged. It avoids the operations of dusting with talc that are usually necessary during the manufacture and assembly of fluid dispenser devices.

To summarize, the method seeks to prepare a thin film on the elastomer support surface. The method mainly comprises putting said support surface into contact with a liquid solution. The liquid solution includes at least one solvent and at least one adhesive primer, enabling radical entities to be formed from the adhesive primer.

The “thin film” may be any polymeric film, in particular of organic nature, e.g. resulting from a plurality of units of organic chemical species, and bonded in covalent manner to the support surface on which the method is performed. In particular, it is a film that is bonded in covalent manner to the support surface, and that includes at least one layer of structural units of similar nature. Depending on the thickness of the film, its cohesion is provided by covalent bonds that develop between the various units. Preferably, the thin film includes hydrophobic agents having anti-static properties.

The solvent used in the context of the method may be of protic or aprotic nature. It is preferable for the primer to be soluble in said solvent.

The term “protic solvent” means a solvent that includes at least one hydrogen atom that is capable of being released in the form of a proton. The protic solvent may be selected from the group constituted by: water; deionized water; optionally-acidified distilled water; acetic acid; hydroxylated solvents such as methanol and ethanol; liquid glycols of small molecular weight such as ethyleneglycol; and mixtures thereof. In a first variant, the protic solvent is constituted solely by a protic solvent or by a mixture of different protic solvents. In another variant, the protic solvent or the mixture of protic solvents may be mixed with at least one aprotic solvent, it being understood that the resulting mixture should present the characteristics of a protic solvent. Acidified water is the preferred protic solvent, and more particularly, acidified distilled water or acidified deionized water.

The term “aprotic solvent” means a solvent that is considered as not being protic. Under non-extreme conditions, such solvents are not suitable for releasing a proton or for accepting one. The aprotic solvent is advantageously selected from: dimethylformamide (DMF); acetone; and dimethyl sulfoxide (DMSO).

The term “adhesive primer” corresponds to any organic molecule that is suitable, under certain conditions, for chemisorbing onto the support surface by a radical reaction, such as radical chemical grafting. Such molecules include at least a functional group that is suitable for reacting with a radical, and also a reactive function that reacts with another radical after chemiabsorption. Thus, after grafting a first molecule to the support surface, the molecules are capable of forming a polymeric film, and then of reacting with other molecules that are present in its environment.

The term “radical chemical grafting” refers, in particular, to the use of molecular entities that possess an unpaired electron in order to form bonds with an elastomer surface of the covalent-bond type, said molecular entities being generated independently of the surface onto which they are to be grafted. Thus, the radical reaction leads to covalent bonds being formed between the elastomer surface under consideration and the derivative of the grafted adhesive primer, and then between a grafted derivative and molecules that are present in its environment.

The term “derivative of the adhesive primer” means a chemical unit resulting from the adhesive primer, after said adhesive primer has reacted by radical chemical grafting, in particular with the elastomer surface, or with another radical. To the person skilled in the art, it is clear that the function that is reactive with another radical after chemiabsorption of the derivative of the adhesive primer is different from the function involved in the covalent bonding, in particular with the support surface. Advantageously, the adhesive primer is a cleavable aryl salt selected from the group constituted by: aryl diazonium salts; aryl ammonium salts; aryl phosphonium salts; aryl sulfonium salts; and aryl iodonium salts.

The elastomer surface is preferably a neck gasket or a valve gasket of a pharmaceutical fluid dispenser device. The gasket may be made out of any appropriate elastomer material, such as ethylene propylene diene monomer (EPDM), chloroprene, nitrile rubber, hydrogenated nitrile butadiene rubber (HNBR), etc.

As a variant to the direct covalent bonds of the hydrophobic molecules on the support surface, as obtained in an aqueous medium, it is also possible to use a method of impregnating a porous layer that has previously been grafted with hydrophobic molecules.

The invention also provides the use of a chemical grafting method of the invention for avoiding the elastomer surfaces sticking during the manufacturing and assembly stages.

The invention also relates to an elastomeric substrate, characterized in that it includes a film that is constituted by grafted polymers comprising at least aryl motifs resulting from a cleavable aryl salt, and at least siloxane motifs.

### Example of a Non-Stick Treatment of Elastomer (EPDM) Strips:

The non-stick treatment of EPDM strips consists in grafting a lubricating coating onto the elastomer strips using GraftFast® technology described in patent application WO 2008/078052, for example.

The strips of 30 centimeters (cm) in length and of 5 cm in width were dipped in a GraftFast® bath containing di-vinylic PDMS (1 gram per liter (g/L)), 4-aminobenzoic acid (0.05 moles per liter (mol/L)), sodium dodecyl sulfate (0.01 mol/L), hydrochloric acid (0.23 mol/L), hypophosphorus acid (0.313 mol/L), and sodium nitrite (0.047 mol/L), for 30 minutes, at ambient temperature, under stirring (30 revolutions per minute (rpm)). In this way, six strips (5 cm×30 cm) were treated vertically (specimen of 2 L) in a volume of 1.6 L.

The strips were then rinsed by a series of four successive rinses: (i) under a cascade of an aqueous solution of surfactant-type detergent (10% vol.) at ambient temperature; (ii) by immersing in an aqueous solution of surfactant-type detergent (10% vol.) that was subjected to ultrasound (100 watts (W)) for 5 minutes at 40° C.; (iii) under a cascade of an aqueous solution of surfactant-type detergent (10% vol.) at ambient temperature; and finally, (iv) by immersing in clear water for 5 minutes under stirring, at ambient temperature.

To finish, the strips were dried under a flow of compressed air until all traces of water had disappeared.

Two test were performed in order to observe the non-stick character of the EPDM strips.

The first test consisted in superposing two treated EPDM strips one on top of the other, and in rolling them up tightly. The roll of strips was held tightly together by a rubber band for 96 hours (h). After four days, the rubber band was removed, and the behavior of the strips was observed on unrolling. No resistance, nor deformation was observed during unrolling. As soon as the rubber band was removed, the strips deployed immediately without any additional help.

In the second test, a treated EPDM strip was rolled up around a tube made of plastics (PP), and was held tightly by a colson cable tie for 96 h. After four days, the tie was cut, and the behavior of the strip was observed on unrolling. No resistance, nor deformation was observed during unrolling. As soon as the tie was cut, the strips deployed without any additional help.

Various modifications may also be envisaged by a person skilled in the art, without going beyond the ambit of the present invention, as defined by the accompanying claims.

1. A treatment method for treating an elastomer surface of a fluid dispenser device, comprising the step of using chemical grafting to form a thin film on at least one support surface of at least one elastomer surface of said dispenser device, said thin film avoiding the elastomer surfaces sticking during the manufacturing and assembly stages.

2. A method according to claim 1, wherein said grafting step comprises putting the elastomer surface into contact, in non-electrochemical conditions, with a solution that includes at least one adhesive primer, said adhesive primer being a cleavable aryl salt, and at least one monomer or polymer selected from the group constituted by vinyl- or acrylic-terminated siloxanes.

3. A method according to claim 2, wherein the cleavable aryl salt is selected from the group constituted by: aryl diazonium salts; aryl ammonium salts; aryl phosphonium salts; aryl sulfonium salts; and aryl iodonium salts.

4. A method according to claim 1, wherein vinyl- or acrylic-terminated siloxanes are selected from the group constituted by: vinyl- or acrylic-terminated polyalkylsiloxanes such as vinyl- or acrylic-terminated polymethylsiloxane; vinyl- or acrylic-terminated polydimethylsiloxane such as polydimethylsiloxane-acrylate (PDMS-acrylate); vinyl- or acrylic-terminated polyarylsiloxanes such as vinyl- or acrylic-terminated polyphenylsiloxane such as polyvinylphenylsiloxane; and vinyl- or acrylic-terminated polyarylalkylsiloxanes such as vinyl- or acrylic-terminated polymethylphenylsiloxane.

5. A method according to claim 1, wherein said chemical-grafting step is initiated by chemical activation.

6. A method according to claim 5, wherein said chemical activation is initiated by the presence of a reducing agent in the solution.

7. A method according to claim 6, wherein the reducing agent is selected from the group constituted by: reducing metals that are possibly finely divided, such as iron, zinc, or nickel; a metal salt that is possibly in the form of a metallocene; and an organic reducing agent such as hypophosphorus acid, or ascorbic acid.

8. A method according to claim 1, wherein said chemical grafting is performed in an aqueous medium.

9. A method according to claim 1, wherein said thin film has a thickness that is less than 1 μm, preferably lying in the range 10 Åto 2000 Å.

10. A method according to claim 1, wherein said dispenser device comprises: a reservoir containing the fluid; a dispenser member, such as a pump or a valve, that is fastened on said reservoir; and a dispenser head that is provided with a dispenser orifice, and this is for actuating said dispenser member.

11. A method according to claim 1, wherein said elastomer surface is a neck gasket and/or a valve gasket of a dispenser member, such as a pump or a valve.

12. A method according to claim 1, wherein said fluid is a pharmaceutical for spraying in nasal or oral manner.

13. The use of a method according to claim 1, for avoiding the elastomer surfaces sticking during the manufacturing and assembly stages.

14. An elastomeric substrate characterized in that it includes a film that is constituted by grafted polymers comprising at least aryl motifs resulting from a cleavable aryl salt, and at least siloxane motifs.
